(19) United States
(12) Patent Application Publication
(10) Pub. No.: US 2011/0109220 A1
(43) Pub. Date: May 12, 2011

(54) Intermittent cyclic permanent illuminating LED lamp

(76) Inventor: Han-Ming Lee, Hsin Chu City (TW)

(21) Appl. No.: 12/590,400

(22) Filed: Nov. 9, 2009

(51) Int. Cl. H01J 1/62

(52) U.S. Cl. 313/483

(57) ABSTRACT

The present invention relates to an intermittent cyclic permanent illuminating LED lamp, comprising a radiating substrate, a plurality of chips, a plurality of conducting wires, 4 insulating pieces, 4 sets of positive and negative conducting pieces, 2 fluorescent layers and transparent adhesive tape, wherein 2 insulating pieces are bonded to the front side and back side of the radiating substrate, the insulating pieces are available for bonding of the 4 sets of positive and negative conducting pieces, and the plurality of conducting wires on the front side and back side of the radiating substrate are provided for serial connection with the plurality of chips and the positive pole and negative pole on the two sides to offer the intermittent switching cyclic permanent lighting effect or achieve the industrial application of multi-serial connection all illuminating and multi-color light selection and control effect.

### BACKGROUND OF THE INVENTION

With the rise of the electronic industry in recent years, the power saving LED lamp as shown in FIG. 6 replaces the traditional tungsten filament bulb and is extensively used in various electronic products. The thermal energy effect of the single high-efficiency chip structure inside the chip cup due to being energized for a prolonged period of time actually results in premature luminous decay of the chips therefore reducing the service life; moreover, the round structure creates the forward focusing light source effect through refraction of the chip cup without uniform lighting in actual applications, making it necessary to make improvements.

### SUMMARY OF THE INVENTION

The primary purpose of the present invention is to provide an intermittent cyclic permanent illuminating LED lamp and in particular to one comprising a radiating substrate, a plurality of chips, a plurality of conducting wires, 4 insulating pieces, 4 sets of positive and negative conducting pieces, 2 fluorescent layers and transparent adhesive tape to achieve the intermittent switching cyclic permanent illuminating lighting control effect.

The secondary purpose of the present invention is to provide an intermittent cyclic permanent illuminating LED lamp and in particular to one wherein 2 insulating pieces are bonded to the front side and back side of the radiating substrate and the insulating pieces are available for bonding of the positive and negative conducting pieces.

One more purpose of the present invention is to provide an intermittent cyclic permanent illuminating LED lamp and in particular to one in which the front side and back side of the radiating substrate may be used for serial connection of the conducting wires with the plurality of chips and positive and negative conducting pieces on the two sides to form 2 sets of single front side and back side parallel loop and provide the intermittent switching cyclic permanent illuminating lighting control effect.

One more purpose of the present invention is to provide an intermittent cyclic permanent illuminating LED lamp and in particular to one wherein the surface of the chips is covered with a fluorescent layer to allow the chips to provide the choice of color system effect of different light sources.

### BRIEF DESCRIPTION OF THE DRAWINGS

FIG. 1 is a 3D diagram of the present invention.

FIG. 2 is a schematic diagram of the components of the present invention.

FIG. 3 is a schematic of 4 sets of positive and negative serial loops of the present invention.

FIG. 4 is a schematic of the positive and negative conducting piece combination on the front side of the present invention.

FIG. 5 is a lighting function schematic of the chips of the present invention.

FIG. 6 is a schematic of the traditional structure.

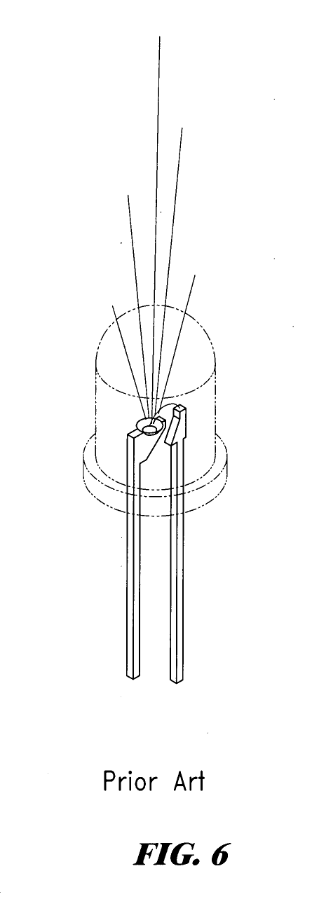

### DETAILED DESCRIPTION OF THE PREFERRED EMBODIMENT

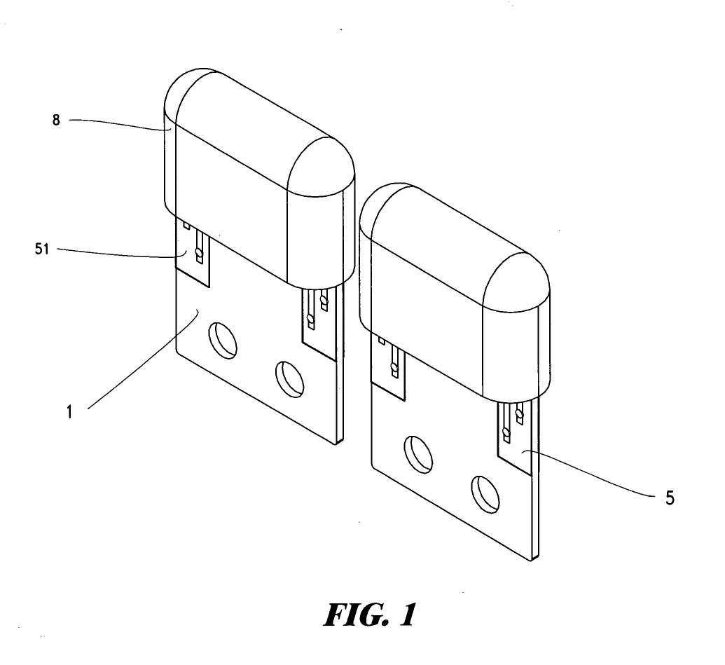

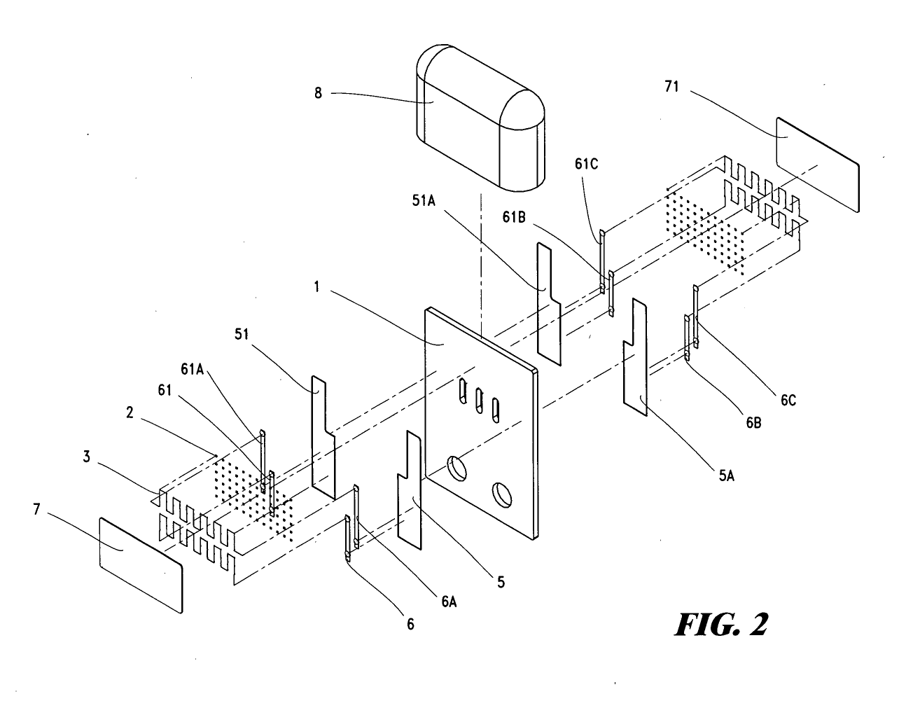

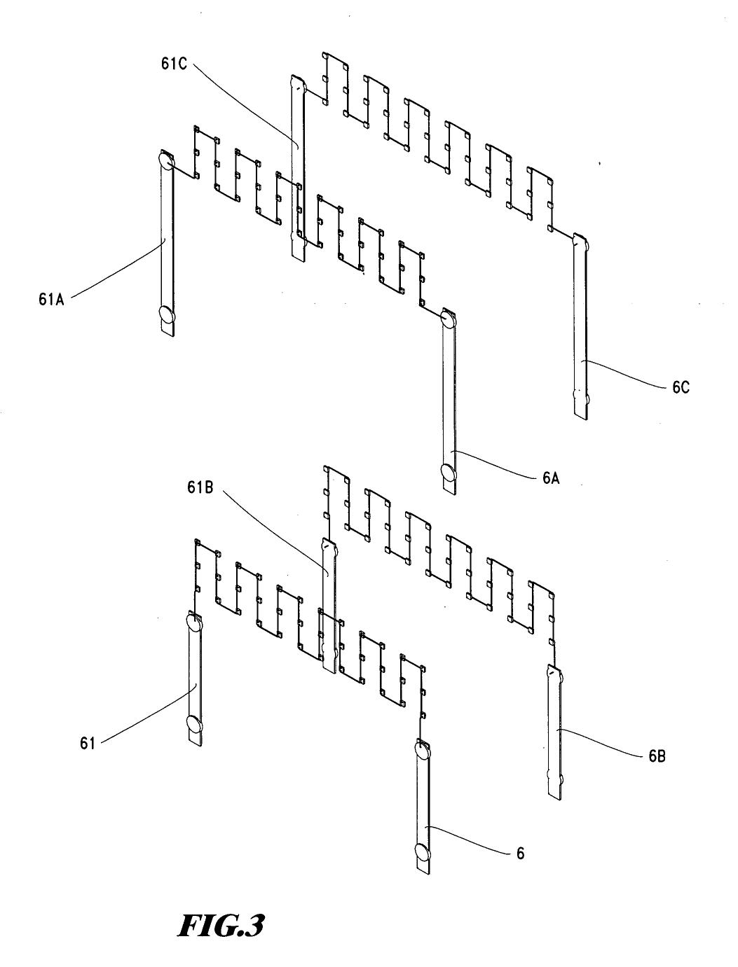

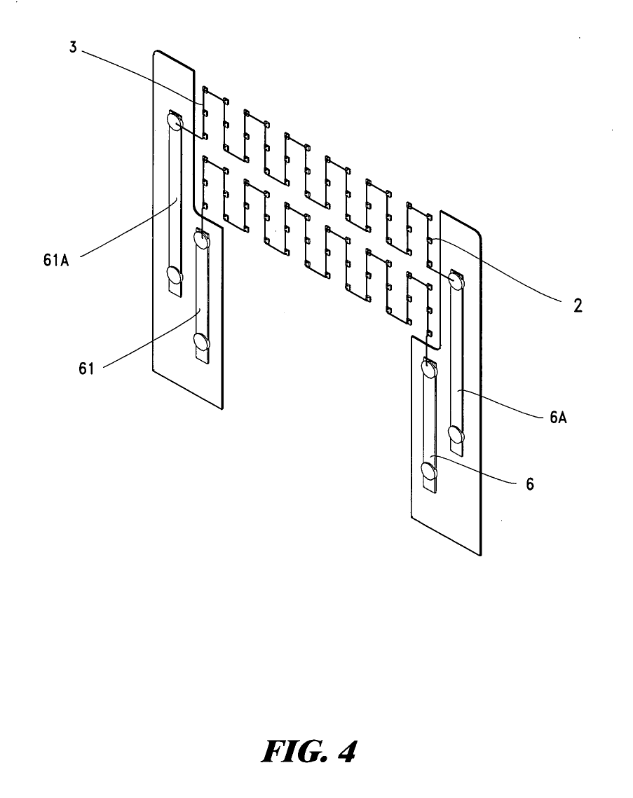

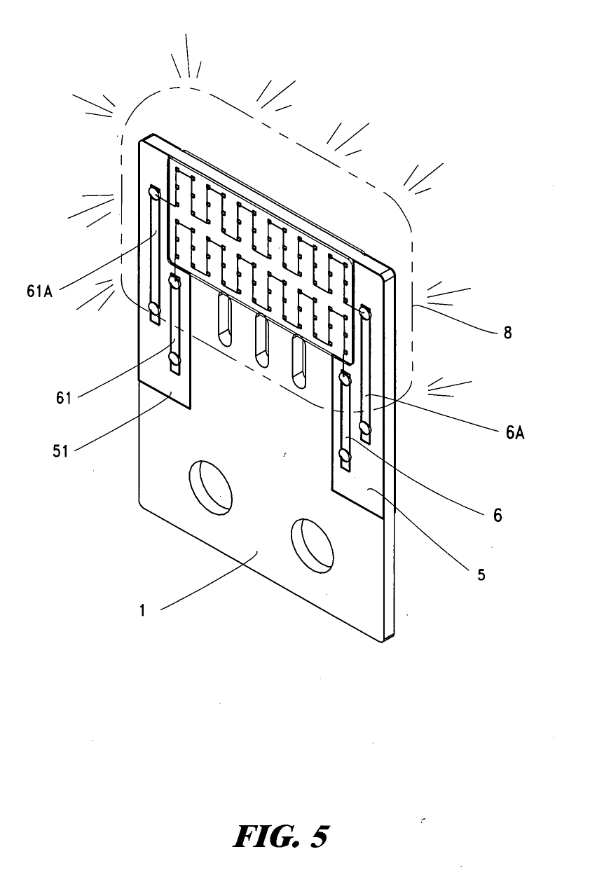

Please refer to FIG. 1 through FIG. 5. The present invention relates to an intermittent cyclic permanent illuminating LED lamp, comprising a radiating substrate 1, a plurality of chips 2, a plurality of conducting wires 3, 4 insulating pieces 5, 51, 5A and 51A, 4 sets of positive and negative conducting pieces 6, 61, 6A, 61A, 6B, 61B, 6C and 61C, 2 fluorescent layers 7 and 71 as well as the transparent adhesive tape 8; the radiating substrate 1 is a rectangle copper radiating substrate; the plurality of chips 2 are a lighting semi-conductor chip distributed and attached to the surface of the radiating substrate 1; the plurality of conducting wires 3 is conducting wire body and its two ends are available for connecting the plurality of chips 2; the 4 insulating pieces 5, 51, 5A and 51A are insulating material bonded to the front side and back side of the radiating substrate; the 4 sets of positive and negative conducting pieces 6, 61, 6A, 61A, 6B, 61B, 6C and 61C are conducting pieces bonded to the surface of insulating pieces 5, 51, 5A and 51A respectively for input of the positive and negative poles and its surface is provided for serial connection of the conducting wire 3 of the chips 2 and connection of the poles; the 2 fluorescent layers 7 and 71 are thin fluorescent containing layers covering the surface of the chip blocks; the transparent adhesive tape 8 is a resin or silicon transmitting injection sealing the radiating substrate, plurality of chips, plurality of conducting wires, insulating pieces, positive and negative conducting pieces and 2 fluorescent layers. Please refer to FIG. 3 through FIG. 5 of the embodiment of the present invention. 4 insulating pieces 5, 51, 5A and 51A are bonded to the front side and back side of the radiating substrate 1, the insulating pieces are provided for bonding of the 4 sets of positive and negative conducting pieces 6, 61, 6A, 61A, 6B, 61B, 6C and 61C and for serial connection of the plurality of conducting wires with the plurality of chips on the surface of the radiating substrate and the positive and negative poles, the chip block on the front side and the back side is designed to be covered with a fluorescent 7 and 71 for the chips to create the color system change effect of different light sources. Moreover, IC may be adopted to control the sets of positive and negative conducting pieces to create the single loop switching intermittent permanent lighting effect.

I claim:

1. An intermittent cyclic permanent illuminating LED lamp, comprising a radiating substrate, a plurality of chips, a plurality of conducting wires, 4 insulating pieces, 4 sets of positive and negative conducting pieces, 2 fluorescent layers and transparent adhesive tape, wherein, the radiating substrate is a rectangle copper radiating substrate; the plurality of chips are a lighting semi-conductor chip distributed and attached to the surface of the radiating substrate; the plurality of conducting wires is conducting wire body and its two ends are available for connecting the plurality of chips; the 4 insulating pieces are insulating material bonded to the front side and back side of the radiating substrate; the 4 sets of positive and negative conducting pieces are conducting pieces bonded to the surface of insulating pieces respectively for input of the positive and negative poles and its surface is provided for serial connection of the conducting wire of the chips and connection of the poles; the 2 fluorescent layers are thin fluorescent containing layers covering the surface of the chip blocks; the transparent adhesive tape is a resin or silicon transmitting injection sealing the radiating substrate, plurality of chips, plurality of conducting wires, insulating pieces, positive and negative conducting pieces and 2 fluorescent layers, the insulating pieces on the front side and back side of the radiating substrate are provided for bonding of 4 sets of positive and negative conducting pieces for serial connection of the plurality of conducting wires with the plurality of chips on the surface of the radiating substrate and the positive and negative poles and the fluorescent layer covering the chip blocks on the front side and back side allows the chips to offer the color system change effect of different light sources; Moreover, IC may be adopted to control the sets of positive and negative conducting pieces to create the single loop switching intermittent permanent lighting effect or multi-loop all illuminating multi-color control effect.
